(19) United States
(12) Patent Application Publication
(10) Pub. No.: US 2010/0084158 A1
(43) Pub. Date: Apr. 8, 2010

(54) Flexible, High Temperature Rated LLDPE Jacket Composition

(76) Inventors: Yimsan Gau, Belle Mead, NJ (US); Ernest P. Caputo, West Chester, OH (US)

Correspondence Address: WHYTE HIRSCHBOECK DUDEK S.C./DOW;Intellectual Property Department, 555 East Wells Street, Suite 1900, Milwaukee, WI, 53202, US

(21) Appl. No.: 12/566,737

(22) Filed: Sep. 25, 2009

Related U.S. Application Data
(60) Provisional application No. 61/103,113, filed on Oct. 6, 2008.

(51) Int. Cl. H01B 3/30; C08L 53/00; C08K 3/04

(52) U.S. Cl. 174/110 SR; 524/505; 525/88

(57) ABSTRACT

Polymer compositions composed of a polyethylene resin (e.g., LLDPE), carbon black and an olefin block interpolymer are provided, which are useful for, among other things, the production of wire and cable jacketing that possess an increased high temperature rating, flexibility and comparable ease of removal of the jacket from the cable core.

### CROSS-REFERENCE TO RELATED APPLICATIONS

This application claims the benefit U.S. Provisional Application 61/103,113 filed Oct. 6, 2008.

### FIELD OF THE INVENTION

Embodiments of the invention relate to thermoplastic polymer compositions and products, including cable jackets made of such material. In one aspect, the invention relates to linear low density polyethylene (LLDPE) blends that have increased flexibility and improved processability. In another aspect, the invention relates to LLDPE materials for wire and cable jackets that have a higher temperature rating (i.e., 105° C. vs. 90° C.), improved flexibility and comparable ease of removal from cables compared to a standard LLDPE jacket material.

### BACKGROUND OF THE INVENTION

Cables for telecommunications and power transmission generally comprise a core surrounded by an outer jacket or sheath based on a thermoplastic polyolefin composition, and can include inner jackets or sheaths. Desired properties of cable jacket materials include good processability, a high level of flexibility, and satisfactory mechanical strength under heating in continuous use and under overload conditions.

Currently, the majority of medium voltage cables operate at a maximum conductor temperature (or high temperature rating) of 90° C. with an emergency temperature of 130° C. as determined by established standards of the Insulated Cable Engineers Association (ICEA). With the trend of increasing ampacities load on medium voltage cables, there has been an increase in some cables of the maximum conductor temperature to 105° C. and the emergency temperature to 140° C. The current temperature rating of medium-density polyethylene (MDPE) and high-density polyethylene (HDPE), for example, is 105° C. according to heat deformation or distortion testing.

With conventional polyethylenes, higher temperature ratings are achieved through increasing the level of crystallinity or density of the polyethylene material. Higher density polyethylene resins (MDPE, HDPE) have higher melting points and improved physical properties, but as a jacket on cable and wires, are harder to handle, less flexible and more difficult to strip and remove.

Linear low density polyethylene (LLDPE) jacket material offers a good balance of physical properties including good low and high temperature performance, toughness, processability and environmental stress crack resistance. However, the temperature rating of LLDPE jackets is only 90° C.

For a 105° C.-rated jacket, heat aging is normally conducted at 121° C., which is above the peak melting point of linear low density polyethylenes (LLDPE). This factor excludes the use of a standard LLDPE jacket in 105° C. applications, and current specifications for 105° C. applications do not include polyethylene jackets.

U.S. published application US 2006/0199905 (Dow Global Technologies, Inc.) describes blends of ethylene/α-olefin interpolymers and one or more polyolefins, and profiles and gaskets made from the blends by profile extrusion or by injection molding. The blends provide a good balance among tensile strength, melt strength and compression set.

There is a need for a more flexible LLDPE composition and jacket that meets the requirements of a temperature rating of 105° C. and has a toughness comparable to current LLDPE products.

### SUMMARY OF THE INVENTION

According to the invention, polymer compositions comprising a polyethylene resin blended with an olefin block interpolymer are provided that have an increased high temperature rating with improved flexibility and similar ease of removal compared to the polymer composition formulated without the olefin block polymer. The compositions of the invention are particularly useful in extrusion processes commonly used in the manufacture of wire and cable jacketing, sheaths and sleeves.

In an embodiment of the invention, the polymer compositions comprises a polyethylene resin at 70-90% by weight and an olefin block interpolymer (e.g., ethylene/α-olefin block polymer) at 1-20% by weight, the olefin block interpolymer having a melt index (I₂) less than 20 g/10 minutes and a density less than 0.900 g/cm³. In another embodiment, the polymer composition comprises a LLDPE resin at 70-90% by weight, olefin block interpolymer(s) at 1-20% by weight, carbon black at 1-15% by weight, and an antioxidant at 0.1-0.5% by weight, the polymer composition having a temperature rating of 105° C. and a flexural modulus of less than 30,000 psi (206.9 MPa) at 20 to 50% less than the polymer composition without incorporation of the olefin block interpolymer (i.e., at 0% by wt.). Preferably, an LLDPE-based polymer composition has a heat deformation (at 121° C.) of less than 60% and preferably less than 30%. It is further preferred that a jacket or sheath formed from the polymer compositions of the invention is easier to remove by mechanical means (e.g., shaving, etc.) from a surface compared to a jacket material formulated with a medium density polyethylene (MDPE) or a high density polyethylene (HDPE) without the addition of an olefin block interpolymer.

In other embodiments, the polyethylene resin of the polymer composition is a low density polyethylene (LDPE), which is blended with an olefin block interpolymer, and can be used to produce a cable jacket with a high temperature rating greater than 70° C., the temperature rating of standard LDPE jacket compositions. In yet other embodiments, the polyethylene resin of the polymer composition is a high density polyethylene (HDPE) or a medium density polyethylene (MDPE) with a cable jacket made from the blend having a lowered flex modulus than an HDPE or MDPE jacket material without the olefin block interpolymer component.

In another embodiment, the invention provides a flexible and high temperature rated wire and cable jacket material formed from a polymer composition comprising a LLDPE polyethylene blended with an olefin block interpolymer. In other embodiments of the invention, a cable is provided having a flexible outer sheath comprising a polymer composition of the invention, the sheath having a flexural modulus of 26,000 to 30,000 psi (179.3 to 206.9 MPa) and a high temperature rating of 105° C.

### DETAILED DESCRIPTION OF THE PREFERRED EMBODIMENT

### Definitions

The numerical ranges in this disclosure are approximate, and thus may include values outside of the range unless otherwise indicated. Numerical ranges include all values from and including the lower and the upper values, in increments of one unit, provided that there is a separation of at least two units between any lower value and any higher value. As an example, if a compositional, physical or other property, such as, for example, melt index or temperature, is from 100 to 500, it is intended that all individual values, such as 100, 101, 102, etc., and sub ranges, such as 100 to 144, 155 to 170, 197 to 200, etc., are expressly enumerated. For ranges containing values that are less than one or containing fractional numbers greater than one (e.g., 1.1, 1.5, etc.), one unit is considered to be 0.0001, 0.001, 0.01 or 0.1, as appropriate. For ranges containing single digit numbers less than ten (e.g., 1 to 5), one unit is typically considered to be 0.1. These are only examples of what is specifically intended, and all possible combinations of numerical values between the lowest value and the highest value enumerated, are to be considered to be expressly stated in this disclosure. Numerical ranges are provided within this disclosure for, among other things, density, melt index, flexural modulus, heat deformation, polymer and/or other component (e.g., carbon block, antioxidant and/or additive/adjuvant) content of the polymer compositions and products, the ethylene, diene and α-olefin acid content of the olefin block interpolymer, and various process parameters.

The term “comprising” and its derivatives are not intended to exclude the presence of any additional component, step or procedure, whether or not the same is specifically disclosed. In order to avoid any doubt, all compositions claimed through use of the term “comprising” may include any additional additive, adjuvant, or compound whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed. The term “or”, unless stated otherwise, refers to the listed members individually as well as in any combination.

“Composition” and like terms mean a mixture of two or more materials. Included in compositions are pre-reaction, reaction and post-reaction mixtures, the latter of which will include reaction products and by-products as well as unreacted components of the reaction mixture and decomposition products, if any, formed from the one or more components of the pre-reaction or reaction mixture.

“Blend”, “polymer blend” and like terms mean a composition of two or more polymers. Such a blend may or may not be miscible. Such a blend may or may not be phase separated. Such a blend may or may not contain one or more domain configurations, as determined from transmission electron spectroscopy, light scattering, x-ray scattering, and any other method known in the art.

“Polymer” means a polymeric compound prepared by polymerizing monomers, whether of the same or a different type. The generic term polymer thus embraces the term homopolymer, usually employed to refer to polymers prepared from only one type of monomer, and the term interpolymer as defined below. It also embraces all forms of interpolymers, e.g., random, block, etc. The term “ethylene/α-olefin polymer” and “olefin block interpolymer” is indicative of interpolymers as described below.

“Interpolymer” means a polymer prepared by the polymerization of at least two different monomers. This generic term includes copolymers, usually employed to refer to polymers prepared from two different monomers, and polymers prepared from more than two different monomers, e.g., terpolymers, tetrapolymers, etc.

“Polyolefin”, “olefin-based polymer” and like terms mean a polymer that comprises more than 50 mole percent units derived from polymerized olefin monomer, for example ethylene or propylene (based on the total amount of polymerizable monomers). Representative polyolefins include polyethylene, polypropylene, polybutene, polyisoprene and their various interpolymers.

“Olefin block copolymer,” “olefin block interpolymer,” “olefin multi-block interpolymer,” “multi-block interpolymer,” “multi-block copolymer” and like terms refer to a polymer comprising two or more chemically distinct regions or segments (referred to as “blocks”) preferably joined in a linear manner, that is, a polymer comprising chemically differentiated units which are joined end-to-end with respect to polymerized ethylenic functionality, rather than in pendent or grafted fashion. In a preferred embodiment, the blocks differ in the amount or type of incorporated comonomer, density, amount of crystallinity, crystallite size attributable to a polymer of such composition, type or degree of tacticity (isotactic or syndiotactic), regio-regularity or regio-irregularity, amount of branching (including long chain branching or hyper-branching), homogeneity or any other chemical or physical property. Compared to block copolymers of the prior art, including copolymers produced by sequential monomer addition, fluxional catalysts, or anionic polymerization techniques, the olefin block interpolymers used in the practice of this invention are characterized by unique distributions of both polymer polydispersity (PDI or M_{w}/Mₙ or MWD), block length distribution, and/or block number distribution, due, in a preferred embodiment, to the effect of the shuttling agent(s) in combination with multiple catalysts used in their preparation. In the context of this disclosure, “olefin block interpolymers” and like terms, explicitly exclude conventional polyethylenes, e.g., LDPE, LLPDE, MDPE, HDPE, etc.

As used with respect to a chemical compound, unless specifically indicated otherwise, the singular includes all isomeric forms and vice versa (for example, “hexane”, includes all isomers of hexane individually or collectively). The terms “compound” refers to organic-, inorganic- and organometal compounds. The term, “atom” refers to the smallest constituent of an element regardless of ionic state, that is, whether or not the same bears a charge or partial charge or is bonded to another atom. The term “amorphous” refers to a polymer lacking a crystalline melting point as determined by differential scanning calorimetry (DSC) or equivalent technique.

“% by weight” of a component of the compositions is based on the total weight of the composition.

### Test Measurements

For purposes of this disclosure, unless otherwise specified, density in g/cm³ of a polymer (“neat”) or polymer blend or composition is according to ASTM D-792; melt index (I₂ at 190° C./2.16 kg) and melt flow index (I₂₁ at 190° C./21.6 kg) in g/10 minutes and melt flow ratio (MFR=I₂₁/I₂) are according to ASTM D-1238; flexural modulus (%) is according to ASTM D-790; heat deformation (%) is according to ASTM D-4565 (i.e., at 121° C.); tensile strength (in psi; MPa) and tensile elongation (in %) is according to ASTM D-638 (conditions: Speed C, 2 in/min. (50 mm/min., Type IV dogbone specimen); peak melting point is by differential scanning calorimetry (DSC); and carbon black content (% by wt.) is according to ASTM D-1603.

### Polyethylene Resin

In embodiments of the invention, the polymer composition of the invention comprises a polyethylene resin and olefin block interpolymer(s). In other embodiments, the polymer composition further comprises carbon black and antioxidant(s). For purposes of this disclosure, polyethylene resins do not include olefin block interpolymers, and vice versa.

Polyethylene resins are formed by means within the skill in the art in processes involving a coordination catalyst such as a Ziegler-Natta or Phillips catalyst, and processes utilizing using a single site catalyst such as a metallocene catalyst or a constrained geometry catalyst (CGC).

In some embodiments, the polyethylene resin comprises a linear low density polyethylene (LLDPE). LLDPEs used in the practice of this invention are ethylene polymers and copolymers prepared by the use of a coordination catalyst, such as a Ziegler-Natta or Phillips catalyst, at high temperature and relatively low pressure. LLDPEs are generally known as linear polymers because of the substantial absence of branch chains of polymerized monomer units pendant from the backbone.

As is well known in the art, the density of a linear ethylene/α-olefin copolymer is a function of both the length of the α-olefin and the amount of such monomer in the copolymer relative to the amount of ethylene, the greater the length of the α-olefin and the greater the amount of α-olefin present, the lower the density of the copolymer. Linear low density polyethylene (LLDPE) is typically an interpolymer of ethylene and at least one α-olefin of 3 to 12 carbon atoms, preferably 4 to 8 carbon atoms (e.g., 1-butene, 1-octene, etc.), that has sufficient α-olefin content to reduce the density of the copolymer to that of LDPE, e.g., 0.910 to 0.925 g/cm³, and preferably 0.918 to 0.922 g/cm³. The melt index (I₂) of the LLDPE resin used in wire and cable applications can be in the range of 0.50 to 2 g/10 minutes and is preferably in the range of 0.6 to 0.9 g/10 minutes.

Polyethylene (PE) copolymers having a density below 0.91 g/cm³ are known interchangeably as ultra low density polyethylene (ULDPE) or very low density polyethylene (VLDPE), which are also linear. The densities of VLDPE or ULDPE polymers generally range from 0.87 to 0.91 g/cm³.

LLDPEs, ULDPEs and VLDPE are heterogeneously branched linear ethylene-based interpolymers that differ from homogeneously branched ethylene-based interpolymers primarily in their comonomer branching distribution. For example, heterogeneously branched interpolymers have a branching distribution in which the interpolymer molecules do not have the same ethylene/comonomer ratio. Heterogeneously branched ethylene-based interpolymers are typically prepared with a Ziegler-Natta catalyst system. These linear interpolymers lack long chain branching (or measurable amounts of long chain branching).

Linear copolymers of ethylene and α-olefin(s) (LLDPEs, VLDPEs and ULDPEs) are well known in the art, as are their processes of preparation. For example, heterogeneous LLDPE can be made using Ziegler-Natta catalysts in a slurry, gas phase, solution or high pressure process, such as described in U.S. Pat. No. 4,076,698 while homogeneous linear ethylene polymers can be made as described in U.S. Pat. No. 3,645,992. Linear copolymers of ethylene and α-olefin(s) are commercially available from, for example, The Dow Chemical Company as DOWLEX® LLDPE resins, ATTANE® ULDPE resins, and FLEXOMER® ethylene/1-hexene polyethylene VLDPE resins. DOWLEX 2038 LLDPE, for example, has a melt index (I₂) of 1.0 g/10 minutes and a density of 0.935 g/cm³.

In other embodiments, a low density polyethylene (LDPE) resin can be combined with one or more olefin block interpolymers to increase the temperature rating of an LDPE jacket composition to greater than the standard temperature of 70° C. (e.g., to 90° C.). LDPE is prepared with a free radical initiator at high temperature and high pressure, and characterized by branched chains of polymerized monomer units pendant from the polymer backbone. LDPE polymers used in wire and cable applications generally have a density between 0.910 and 0.925 g/cm³ and a melt index (I₂) less than 0.5 g/10 minutes.

In yet other embodiments, a medium density polyethylene (MDPE) or high density polyethylene (HDPE) can be blended with an olefin block interpolymer(s) to decrease the flexural modulus, for example, from 90,000 psi (621 MPA) to 60,000 psi (413.8 MPA). HDPE, which generally has a density of 0.941 to 0.965 g/cm³ and a melt index (I₂) of less than 0.5 g/10 min., contains few branch chains relative to the various linear copolymers of ethylene and an α-olefin. MDPE is generally defined by a density range of 0.926 to 0.940 g/cm³ and a melt index (I₂) of less than 1 g/10 min. LDPE, LLDPE, MDPE and HDPE resins are well known and commercially available in various grades, for example, from The Dow Chemical Company.

The polyethylene resin (e.g., LLDPE, etc.) can be included in the polymer composition in the range of 70 to 90 wt %, and preferably 80 to 90 wt %.

### Olefin Block Interpolymers

The polymer compositions of the invention comprise the polyethylene resin and at least one olefin block interpolymer, which can be included in the polymer compositions in the range of 1 to 20 wt %, and preferably at 10 to 15 wt %.

The block copolymer structure of the olefin block interpolymer provides the polymer composition with an increased level of flexibility and temperature rating. Compounding an effective amount of olefin block interpolymer with an LLDPE resin (and carbon black) improves flexibility by decreasing the flexural modulus of the polymer composition by 20 to 70% (e.g., from 55,000 to 27,000 psi, or from 379.3 to 186.2 MPa) and increases the temperature rating to 105° C. compared to an LLDPE polymer composition (prepared with carbon black and without the olefin block interpolymer) having a standard temperature rating of 90° C., as measured by heat deformation test according to ASTM D-4565.

The olefin block interpolymers used in the practice of this invention are described in the context of ethylene multi-block copolymers with the understanding that these copolymers are exemplary of the olefin block interpolymers in general. The ethylene multi-block copolymers are made with two catalysts incorporating differing quantities of comonomer, and these copolymers have a weight ratio of blocks from 95:5 to 5:95. The elastomeric polymers desirably have an ethylene content of from 20 to 90% by weight, optionally a diene content of from 0.1 to 10% by weight, and an α-olefin content of from 10 to 80% by weight, based on the total weight of the polymer. Further preferably, the multi-block elastomeric polymers of this embodiment have an ethylene content of from 60 to 90% by weight, a diene content of from 0.1 to 10% by weight, and an α-olefin content of from 10 to 40% by weight, based on the total weight of the polymer.

Preferred olefin block interpolymers are high molecular weight ethylene multi-block copolymers having a weight average molecular weight (M_{w}) from 10,000 to 2,500,000, preferably from 20,000 to 500,000, more preferably from 20,000 to 350,000; a polydispersity index (PDI, or M_{w}/Mₙ) of less than 3.5, more preferably less than 3 and as low as 2; and a Mooney viscosity (ML(1+4)@125° C.) from 1 to 250. More preferably, the ethylene multi-block copolymers have an ethylene content from 65 to 75%, a diene content from 0 to 6%, and an α-olefin content from 20 to 35%.

Ethylene multi-block copolymers useful in the practice of this invention have a density of less than 0.90 g/cm³, preferably less than 0.89 g/cm³, more preferably less than 0.885 g/cm³, even more preferably less than 0.88 g/cm³ and even more preferably less than 0.875 g/cm³. The ethylene multi-block copolymers typically have a density greater than 0.85 g/cm³, and more preferably greater than 0.86 g/cm³. Generally, the greater the α-olefin content of the interpolymer, the lower the density and the more amorphous the interpolymer.

Ethylene multi-block copolymers useful in the practice of this invention typically have a melt index (I₂) greater than 1 g/10 minutes and preferably greater than 3 g/10 minutes, and typically less than 20 g/10 minutes and preferably less than 10 g/10 minutes.

The ethylene multi-block copolymers also typically have a melting point of less than 125° C., as measured by the differential scanning calorimetry (DSC) method described in WO 2005/090427 (US 2006/0199930). Ethylene multi-block copolymers exhibit desirable flexibility and thermoplasticity properties useful in the fabrication of the compositions and products of this invention.

Ethylene multi-block copolymers used in the practice of this invention, and their preparation and use, are more fully described in WO 2005/090427, US 2007/0167315, US 2006/0199931, US 2006/0199930, US 2006/0199914, US 2006/0199912, US 2006/0199911, US 2006/0199910, US 2006/0199908, US 2006/0199907, US 2006/0199906, US 2006/0199905, US 2006/0199897, US 2006/0199896, US 2006/0199887, US 2006/0199884, US 2006/0199872, US 2006/0199744, US 2006/0199030, US 2006/0199006 and US 2006/0199983.

Representative olefin block interpolymers include the ethylene multi block copolymers manufactured and sold by The Dow Chemical Company under the trademark INFUSE™ and described in U.S. Pat. No. 7,355,089. INFUSE™ polymers are generally narrow in molecular weight distribution (MWD) (e.g., melt flow ratio (I₂₁/I₂) less than 30 (I₂₁ flow index at 21.6 kg at 190° C. and I₂=melt index at 2.16 kg at 190° C.) which can negatively affect the processability of the polyethylene (e.g., LLDPE, LDPE, HDPE, MDPE, etc.) blends. To compensate for the narrow MWD and positively affect the processability of the polymer blend, one or more INFUSE™ polymers having a high melt index (I₂) that is greater than 3 g/10 minutes, or 4 to 10 g/10 minutes, can be compounded with the polyethylene resin or blend.

Blends of the olefin block interpolymers can also be used in this invention, and the olefin block interpolymers can be blended or diluted with one or more other polymers to the extent that, in a preferred mode, the olefin block interpolymers constitute at least 50 wt %, preferably at least 75 wt % and more preferably at least 80 wt % of the polymer component of such a polymer blend.

### Additives

The polymer compositions of the invention are typically formulated with additives such as, for example, carbon black for UV absorption and to improve stability and antioxidants or anti-ozone additives for chemical protection by reacting with oxygen or ozone.

Representative examples of carbon blacks include ASTM grade N110, N121, N220, N231, N234, N242, N293, N299, S315, N326, N330, M332, N339, N343, N347, N351, N358, N375, N539, N550, N582, N630, N642, N650, N683, N754, N762, N765, N774, N787, N907, N908, N990 and N991. These carbon blacks have iodine absorptions ranging from 9 to 14 g/kg and average pore volumes ranging from 10 to 150 cm³/100 g. Generally, smaller particle sized carbon blacks are employed, to the extent cost considerations permit. The carbon black can be included in the polymer composition in the range of 1 to 5 wt % and preferably 2 to 3 wt %. A preferred carbon black for use in wire and cable jacketing compounds to achieve good weathering performance is N110-type carbon black.

Examples of antioxidants include phenolic- or amine-type antioxidants, for example, styrenated phenols, butylated octylated phenol, butylated di(dimethylbenzyl) phenol, p-phenylenediamines, butylated reaction products of p-cresol and dicyclopentadiene (DCPD), polyphenolic antioxidants, hydroquinone derivatives, quinoline, diphenylene antioxidants, thioester antioxidants, and blends thereof. Some representative trade names of such products are Wingstay® S antioxidant, Polystay® 100 antioxidant, Polystay® 100 AZ antioxidant, Polystay® 200 antioxidant, Wingstay® L antioxidant, Wingstay® LHLS antioxidant, Wingstay® K antioxidant, Wingstay® 29 antioxidant, Wingstay® SN-1 antioxidant, and Irganox® antioxidants. In some applications, the antioxidants and anti-ozonants used will preferably be non-staining and non-migratory. Antioxidants can be used in amounts of 0.1 to 0.5 wt %. In preferred embodiments, an amine-type antioxidant is incorporated into an LLDPE jacket formulation.

Further examples of antioxidants are as follows, but are not limited to: hindered phenols such as tetrakis[methylene(3,5-di-tert-butyl-4-hydroxyhydro-cinnamate)]methane; bis[(beta-(3,5-ditert-butyl-4-hydroxybenzyl)-methylcarboxyethyl)]sulphide, 4,4′-thiobis(2-methyl-6-tert-butylphenol), 4,4′-thiobis(2-tert-butyl-5-methylphenol), 2,2′-thiobis(4-methyl-6-tert-butylphenol), and thiodiethylene bis(3,5-di-tert-butyl-4-hydroxy)hydrocinnamate; phosphites and phosphonites such as tris(2,4-di-tert-butylphenyl)phosphite and di-tert-butylphenyl-phosphonite; thio compounds such as dilaurylthiodipropionate, dimyristylthiodipropionate, and distearylthiodipropionate; various siloxanes; polymerized 2,2,4-trimethyl-1,2-dihydroquinoline, n,n′-bis(1,4-dimethylpentyl-p-phenylenediamine), alkylated diphenylamines, 4,4′-bis(alpha,alpha-demthylbenzyl)diphenylamine, diphenyl-p-phenylenediamine, mixed di-aryl-p-phenylenediamines, and other hindered amine antidegradants or stabilizers.

The reactive blends and polymer compositions of this invention can also contain compatible processing aids. Examples of processing aids include but are not limited to waxes (e.g., polyethylene waxes, vegetable waxes, petroleum waxes), metal salts of carboxylic acids such as zinc stearate or calcium stearate; fatty acids such as stearic acid, oleic acid, or erucic acid; fatty amides such as stearamide or N,N′-ethylenebis-stearamide; polymers of ethylene oxide; copolymers of ethylene oxide and propylene oxide; nonionic surfactants; and polysiloxanes. Fluoropolymer-type processing aids, such as Viton® fluoropolymers from DuPont or Dynamar® from 3M Company, can be included to control die drool. Processing aids can be used in amounts of 0.01 to 0.05 wt %.

### Preparation of the Polymer Blends

The components of the polymer compositions, i.e., the polyethylene (e.g., LLDPE, etc.) resin, the olefin block interpolymer and additives including carbon black, antioxidant, and optional additives, can be mixed or blended using methods known to a person of ordinary skill in the art, preferably methods that can provide a substantially homogeneous distribution of the olefin block interpolymer and the additives in the polyethylene resin.

In embodiments of the invention, the polymer composition is prepared by combining a polyethylene (e.g., LLDPE) resin in the range of 70 to 90 wt %, and preferably 80 to 90 wt %, and an olefin block interpolymer(s) in the range of 1 to 20 wt %, and preferably 10 to 15 wt %. The polymer compositions can further include a carbon black component in the range of 1 to 5 wt % and preferably 2 to 3 wt %, and an antioxidant in the range of 0.1 to 0.5 wt %, preferably 0.15 to 0.25 wt %.

The polymer compositions can be prepared by mixing or kneading the respective components at a temperature around or above the melt point temperature of one or both of the polymer components. For most multiblock copolymers, this temperature may be above 130° C., most generally above 145° C., and most preferably above 150° C. Typical polymer mixing or kneading equipment that is capable of reaching the desired temperatures and melt plasticating the mixture can be employed. These include mills, kneaders, extruders (both single screw and twin-screw), Banbury mixers, Brabender mixers, calenders, and the like. The sequence of mixing and method may depend on the final composition. A combination of batch mixer (e.g., Banbury mixer) and continuous mixer (e.g., single screw extruder) can also be employed, such as a Banbury mixer followed by a mill mixer followed by an extruder, for preparing homogenous blends.

The desired amounts of additives can be added in one charge or multiple charges to the polyethylene (e.g., LLDPE, etc.) resin, the olefin block interpolymer, or a polymer blend. Furthermore, the addition can take place in any order. In some embodiments, the additives (i.e., carbon black, antioxidant, etc.) are first added and blended with the polyethylene (e.g., LLDPE, etc.) resin and then the additive-containing polyethylene resin is blended with the olefin block interpolymer.

Examples of commercially available LLDPE resin materials containing carbon black for wire and cable applications include DFDG-6059 BK LLDPE black jacketing compound (MI=0.60 g/10 min. @190° C./2.16 kg, D=0.932 g/cm³, TS=2350 psi (16.2 MPa), TE7800%) available from The Dow Chemical Company. Examples of commercially available HDPE, MDPE and LDPE resin materials containing carbon black for wire and cable applications include, for example, DGDK-3479 BK HDPE black jacketing compound (MI=0.20 g/10 min. @190° C./2.16 kg, D=0.95 g/cm³, TS=4200 psi (29 MPa), TE=800%); DGDA-3479 BK HDPE black jacketing compound (MI=0.70 g/10 min. @190° C./2.16 kg, D=0.954 g/cm³, TS=3200 psi (22 MPa), TE=600%); DHDA-6548 BK MDPE black jacketing compound (MI=0.70 g/10 min. @190° C./2.16 kg, D=0.947 g/cm³, TS=3000 psi (26.8 MPa), TE=800%); DHDA-8864 BK MDPE black jacketing compound (MI=0.70 g/10 min. @190° C./2.16 kg, D=0.941 g/cm³, TS=4100 psi (28.2 MPa), TE=800%); DFDC-0588 BK LDPE black jacketing compound (MI=0.34 g/10 min. @190° C./2.16 kg, D=0.432 g/cm³, TS=2375 psi (16.4 MPa), TE=700%), which are available from The Dow Chemical Company.

In other embodiments, the additives are first added and mixed or blended with the olefin block interpolymer, which is then blended with the polyethylene resin. In further embodiments, the olefin block interpolymer is blended with the polyethylene resin first and then the additives are blended with the polymer blend. In embodiments in which a carbon black component is added directly to the polymers or polymer blend, it generally requires control of dust around the compounding unit and a relatively intense mixing apparatus to mix the “raw” carbon black with the polymer resins.

In other embodiments, master batches containing high concentrations of the additives can be used. In general, a master batch can be prepared by blending the polyethylene resin (e.g., LLDPE), the olefin block interpolymer or the polymer blend with a high concentration of additive(s). The master batch can have additive concentration(s) from 1 to 50 wt %, from 1 to 40 wt %, from 1 to 30 wt %, or from 1 to 20 wt % of the total weight of the master batch composition. The master batch can then be added to the polyethylene resin, olefin block interpolymer or the polymer blend in an amount determined to provide the desired additive concentrations in the end products.

In some embodiments, the master batch contains carbon black, which can be blended or compounded with the polyethylene resin (e.g., LLDPE), olefin block interpolymer, an additive polymer (e.g., HDPE, LDPE, etc.), or a polymer blend. In some embodiments, the master batch contains carbon black and an antioxidant and/or optional other additives such as anti-ozonants, UV absorbers and/or light stabilizers (e.g., hindered amine light stabilizers (HALS)), or other optional additives. Carbon black master batches are available commercially from the Dow Chemical Company and many compounders such as A. Schulman Inc., and can have high loadings of carbon black, for example, at 30 to 45% by weight.

### Applications and End Uses

The polymer compositions of this invention can be processed by conventional molding techniques such as extrusion, coating and other processing techniques that are well known to those skilled in the art of polyolefin processing.

The polymer compositions and products according to the invention can be used in applications that require thermal stability, ozone and weathering resistance, oxidative stability, good electrical properties, low temperature properties and/or chemical resistance. Such applications include, for example, wire and cable jackets among other applications. For the production of a wire and cable jacket, the polymer composition can be melt extruded onto a cable core to form a jacketing and then thermally cooled in continuous fashion.

LLDPE polymer compositions according to the invention utilized as wire and cable jacketing compounds possess flexibility, toughness and processability, with an increased temperature rating to 105° C., and preferably a high resistance to die-drool. Die drool (i.e., resin build-up on die surfaces of an extruder, etc.) can be determined by visual observation, for example, of a die surface after extruding a polymer composition for a period of time.

Unlike polymer blends in which one parameter is improved (e.g., flexibility) while another parameter is negatively affected (e.g., temperature rating), the present polymer compositions provides a balance of three important properties within a single compound, i.e., improved flexibility, a higher temperature rating and a comparable ease of removal from a cable core for cable connection relative to a standard jacket material without the addition of the olefin block interpolymer component. LLDPE compositions of the invention possess a balance of improved flexibility with an 20 to 70%, preferably 30 to 60% and preferably 40 to 50% reduction in flexural modulus, an increased temperature rating to meet the requirements of a 105° C. rating comparable to that of a standard MDPE/HDPE jacket material (i.e., without olefin block copolymer), and a comparable ease of removal from a wire or cable core for cable connection comparable to that of the unmodified standard LLDPE jacket material and a less difficult removal from a cable core or other structure than a standard MDPE or HDPE jacket material. Additionally, LLDPE compositions formulated with an olefin block interpolymer such as an INFUSE™ resin possess a high level of control of shrinkback in a cable jacket material as can be measured by ASTM D-4565.

### SPECIFIC EMBODIMENTS

The following examples are presented to illustrate embodiments of the invention. All parts and percentages are by weight unless otherwise indicated. When numerical ranges are given, it should be understood that embodiments outside the stated ranges may still fall within the scope of the invention.

### Example 1

Three INFUSE™ olefin block interpolymers (Dow Chemical Company) were selected for compounding in an LLDPE cable jacketing compound DFDG-6059 Black (Dow Chemical Company) to assess improvement in flexibility and high temperature rating. The DFDG-6059 compound, which is composed of an enhanced antioxidant system and low moisture absorption carbon black, was used in the tests to avoid compounding steps of making the LLDPE jacket compound from the LLDPE resin, black masterbatch (carbon black), antioxidant and the INFUSE™ polymers.

Properties of the LLDPE DFDG-6059 Black jacket compound include: density of 0.932 g/cm³ (ASTM D-792, 23° C.), melt index of 0.6 g/10 min., tensile strength of 2.350 psi (16.2 MPa) and tensile elongation of 700%, (ASTM D-638; speed C, 50 mm/min., Type IV dogbone specimen) and a carbon black content of 2.60% (ASTM D-1603).

Table 1 (below) lists the composition melt index and density, and product features of the LLDPE DFDG-6059 black jacket compound blended with three INFUSE™ olefin block interpolymers. The INFUSE™ polymers were selected based on processability (high melt index, i.e., greater than 3 g/10 min. and Shore A hardness, which provided an indication of the higher level of hard block copolymer for higher temperature rating.

TABLE 1
Evaluation of INFUSE ™ polymers in LLDPE Jacket Compound

| | MI @ 190° C. | Density | |
|---|---|---|---|
| INFUSE ™ polymer | (g/10 min.) | (g/cm³) | Product Features |
| INFUSE ™ D9500.00 | 5 | 0.877 | 74 Shore A hardness, low compression |
| | | | set, general extrusion grade |
| INFUSE ™ D9530.00 | 5 | 0.887 | 85 Shore A hardness, low compression |
| | | | set, low shrinkage, high tear |
| INFUSE ™ D9817.10 | 15 | 0.877 | 85 Shore A hardness, low compression |
| | | | set, injection molding grade |

The formulations and results are shown in Table 2 below. The polymer compositions, Formulations I (A-10) and III (B-10) were prepared by blending together 90 wt % LLDPE DFDG-6059 compound with 10 wt % INFUSE™ D9530.00 and 10 wt % INFUSE™ D9817.10, respectively. The Formulations II (A-20) and IV (B-20) were composed of 80 wt % of the DFDG-6059 compound combined 20 wt % INFUSE™ D9530.00 and INFUSE™ D9817.10, respectively.

TABLE 2
Test Examples of Formulations of INFUSE ™ polymers
in LLDPE Jacket Compound (% by weight).

| | Formulation | | | |
|---|---|---|---|---|
| | (I) | (II) | (III) | (IV) |
| | A-10 | A-20 | B-10 | B-20 |
| Components | (10%-wt) | (20%-wt) | (10%-wt) | (20%-wt) |
| DFDG-6059 compound | 90 | 80 | 90 | 80 |
| INFUSE ™ D9530.00 | 10 | — | — | — |
| | — | 20 | — | — |
| INFUSE ™ D9817.10 | — | — | 10 | — |
| | — | — | — | 20 |
| TOTAL | 100 | 100 | 100 | 100 |

The test results are shown in Table 3 below.

TABLE 3
Test Results from Examples of Optimized Formulations I and III

| | | DFDG-6059 | | Test Formulation | | Test Formulation | |
|---|---|---|---|---|---|---|---|
| | | compound | | I (A-10) | | III (B-10) | |
| Properties | ASTM Specs | (Control) | | (10%-wt) | | (10%-wt) | |
| Density, g/cm³ | D-792 | 0.932 | | 0.9304 | | 0.9306 | |
| MI (190° C./2.16 kg), g/10 min. | ASTM D-1238 | 0.55 | | 0.86 | | 0.91 | |
| MFR (190° C./2.16 kg), g/10 min. | ASTM D-1238 | 80 | | 66 | | 68 | |
| Flexural (Flex) Modulus, psi (MPa) | D-790 | 55,000 | psi | 29,500 | psi | 27,100 | psi |
| | | (379.31 | MPa) | (203.45 | MPa) | (186.89 | MPa) |
| Tensile Strength (T), psi (MPa) | D-638 | 2350 | psi | 1923 | psi | 1893 | psi |
| | | (16.20 | MPa) | (13.2 | MPa) | (13.05 | MPa) |

| | | | | |
|---|---|---|---|---|
| Elongation (E), % | D-638 | 700 | 727 | 713 |
| Aged T @ 100° C./7 days, % Retained | D-638 | 90 | 89 | 90 |
| Aged E @ 100° C./7 days, % Retained | D-638 | 95 | 100 | 100 |
| Aged T @ 121° C./7 days, % Retained | D-638 | 60 | 80 | 82 |
| Aged E @ 121° C./7 days, % Retained | D-638 | 80 | 95 | 98 |
| Heat Deformation @ 121° C., % | D-4565 | 72 | 11 | 14 |

The results show a significant improvement in flexibility and heat deformation at 121° C. of the test formulations I and III. Heat deformation was used as an indication of the temperature rating of the jacket material at a given testing temperature. Under ICEA S-93-639 standards, for example, a heat deformation or heat distortion test is used as the standard for temperature rating of different cable jackets. A jacket for power cables can also be submitted for thermal mechanical testing as described in AEIC CS-8-2000.

In the present example, the flex modulus was reduced by almost 50% and heat deformation was reduced from 72% to 10-15%. By comparison, MDPE and HDPE black jacket materials have demonstrated a “0%” heat deformation at 121° C. and, due to hardness and difficulties in removing the extruded encapsulated jacket as used in North America for splicing, such material has proven undesirable as a cable jacketing material for a 105° C. temperature rating.

The optimized LLDPE formulations I and III of the invention (Table 3) had a melt flow ratio (MFR) of 66 and 68 g/10 minutes, which was slightly lower than that of the standard LLDPE jacket material (control) at 80 g/10 minutes. From a processability standpoint, the slightly lower MFR did not significantly affect the processability of the optimized LLDPE formulations.

Table 4 (below) lists the standard properties of LLDPE black jacket compounds as listed in ICEA S93-639 (Insulated Cable Engineers Association).

TABLE 4
LLDPE Black Jacket Specifications

| | Test | LLDPE Black |
|---|---|---|
| Properties | Method | Jacket Specs |
| Tensile Strength (T)⁽¹⁾ minimum | ASTM D-638 | 1700 psi |
| | | (11.72 MPa) |
| Tensile Elongation (E)⁽¹⁾ minimum, % | ASTM D-638 | 350% |
| Aged T, 100° C./7 days, % retained | ASTM D-638 | 75 |
| Aged E, 100° C./7 days, % retained | ASTM D-638 | 75 |
| Aged T, 121° C./7 days, % retained | ASTM D-638 | 75⁽²⁾ |
| Aged E, 121° C./7 days, % retained | ASTM D-638 | 75⁽²⁾ |
| Heat Deformation at 100° C., max % | ASTM D-4565 | 30 |
| Heat Deformation at 121° C., max % | ASTM D-4565 | 30⁽²⁾ |

⁽¹⁾Speed C, 50 mm (2 in)/minute; Type IV dogbone specimen
⁽²⁾Proposed value

It is noted that the minimum tensile strength of the LLDPE jacket material is 1700 psi (11.72 MPa) by standard cable specifications. Under ICEA standards, the heat deformation specification for LLDPE is 30% maximum at 100° C. To allow the improved LLDPE compositions of the invention to be used in 105° C.-rated jacket applications, the proposed heat deformation specification of the LLDPE jacket material of the invention would be 30% maximum at 121° C. The improved LLDPE formulations of the invention meet that proposed heat deformation specification of 30% maximum at 121° C.

### Example 2

To define the range of INFUSE™ polymer in the LLDPE jacket material, Formulation II (A-20) and Formulation IV (B-20) (Table 2) composed of 80 wt % of the DFDG-6059 compound combined with 20 wt % of INFUSE™ D9530.00 and 20 wt % of INFUSE™ D9817.10, respectively, were evaluated. The results are shown in Table 5 below.

TABLE 5
Range of INFUSE ™ polymer in LLDPE Jacket Compound
to Improve Flexibility and Temperature Rating

| | | DFDG-6059 | | Formulation | | Formulation | |
|---|---|---|---|---|---|---|---|
| Properties | Test Method | (Control) | | II (A-20) | | IV (B-20) | |
| Density, g/cm³ | ASTM D-792 | 0.932 | | 0.9253 | | 0.9253 | |
| MI (190° C./2.16 kg), g/10 min. | ASTM D-1238 | 0.55 | | 1.23 | | 1.42 | |
| MFR (MI @190° C./21.6 kg/ | ASTM D-1238 | 80 | | 51 | | 55 | |
| MI @ 190° C./2.16 kg) | | | | | | | |
| Flexural (Flex) Modulus, psi (MPa) | ASTM D-790 | 55,000 | psi | 26,000 | psi | 24,000 | psi |
| | | (379.31 | MPa) | (179.31 | Mpa) | (165.51 | Mpa) |
| Tensile Strength (T), psi (MPa)⁽¹⁾ | ASTM D-638 | 2350 | psi | 1635 | psi | 1544 | psi |
| | | (16.20 | MPa) | (11.28 | MPa) | (10.65 | MPa) |

| | | | | |
|---|---|---|---|---|
| Tensile Elongation (E), %⁽¹⁾ | ASTM D-638 | 700 | 702 | 569 |
| Aged T, 100° C./7 days, % retained | ASTM D-638 | 90 | 94 | 90 |
| Aged E, 100° C./7 days, % retained | ASTM D-638 | 95 | 100 | 20 |
| Aged T, 121° C./7 days, % retained | ASTM D-638 | 60 | 88 | — |
| Aged E, 121° C./7 days, % retained | ASTM D-638 | 80 | 96 | — |
| Heat Deformation at 121° C., max % | ASTM D-4565 | 72 | 14 | 29 |

⁽¹⁾Speed C, 50 mm (2 in)/minute; Type IV dogbone specimen

With Formulation II (A-20) composed of 20 wt % of INFUSE™ D9530.00 in 80 wt % LLDPE DFDG-6059 compound, the unaged tensile strength was less than 11.72 MPa (1700 psi). The interpolated percent (%) of INFUSE™ D9530.00 to meet 11.72 MPa (1700 psi) of unaged tensile strength was at 17 wt %.

With Formulation IV (B-20) composed of 20 wt % of INFUSE™ D9817.10 in 80 wt % LLDPE DFDG-6059 compound, the unaged tensile strength was less than 11.72 MPa (1700 psi). The interpolated maximum weight percent (wt %) of INFUSE™ D9530.00 to provide an unaged tensile strength at 11.721 MPa (1700 psi) was at 15 wt %.

The results showed that the LLDPE black jacket material compounded with an olefin block interpolymer (e.g., INFUSE™ D9530.00 and INFUSE™ D9817.10) up to an amount of 15 wt % can yield a much improved flexibility (i.e., near 50% reduction in flex modulus), a higher temperature rating (i.e., from 90° C. to a 105° C. temperature rating) as confirmed by the good heat deformation at 121° C. of less than 30%, and meet other tensile and elongation properties of the delineated cable specifications. The heat deformation test is typically conducted about 16° C. above the actual use temperature of the jacket.

Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations that operate according to the principles of the invention as described. Therefore, it is intended that this invention be limited only by the claims and the equivalents thereof. The disclosures of patents, references and publications cited in the application are incorporated by reference herein.

What is claimed is:

1. A polymer composition, comprising:
70-90% by weight LLDPE resin;
1-20% by weight olefin block interpolymer;
1-15% by weight carbon black; and
0.1-0.5% by weight antioxidant;
the % by weight based on the total weight of the composition; and
the polymer composition having a heat deformation of less than 30% at 121° C. (as measured by ASTM D-4565) and a flexural modulus below 30,000 psi (206.90 MPa) (as measured by ASTM D-790).

2. The polymer composition of claim 1, wherein the flexural modulus is 20% to 50% less than the polymer composition having 0% by weight of olefin block interpolymer.

3. The polymer composition of claim 1, having a heat deformation as measured by ASTM D-4565 (121° C.) of less than 30% and suitable for use in a 105° C.-rated cable jacket.

4. A polymer composition, comprising:
70-90% by weight polyethylene resin; and
1-20% by weight ethylene/α-olefin block polymer having a melt index (I₂) less than 15 g/10 minutes as measured by ASTM D-1238 (190° C./2.16 kg) and a density less than 0.900 g/cm³ (ASTM D-792);
the polymer composition having a higher temperature rating and a lower flexural modulus than the polymer composition without the olefin block interpolymer; the % by weight based on the total weight of the composition.

5. The polymer composition of claim 4, further comprising 1-5% by weight carbon black.

6. The polymer composition of claim 4, wherein the polyethylene resin is a linear low density polyethylene (LLDPE).

7. The polymer composition of claim 6, wherein the density of the LLDPE is 0.910-0.925 g/cm³, as measured by ASTM D-792.

8. The polymer composition of claim 6, wherein the composition density is 0.925 to 0.931 g/cm³, as measured by ASTM D-792.

9. The polymer composition of claim 4, wherein the polyethylene resin is prepared with a Ziegler-Natta catalyst.

10. The polymer composition of claim 4, wherein the polyethylene resin is prepared using a metallocene catalyst.

11. The polymer composition of claim 11, wherein the metallocene catalyst is a constrained geometry catalyst (CGC).

12. The polymer composition of claim 4, wherein the polyethylene resin is a low density polyethylene (LDPE).

13. The polymer composition of claim 13, wherein the high temperature rating of the polymer composition is greater than 70° C., as measured by heat deformation according to ASTM D-4565 (at 100° C.).

14. The polymer composition of claim 4, wherein the polyethylene resin is a high density polyethylene (HDPE).

15. The polymer composition of claim 4, wherein the polyethylene resin is a medium density polyethylene (MDPE).

16. The polymer composition of claim 5, wherein the polymer composition has a flexural modulus of 20 to 70% less than the polymer composition without the olefin block interpolymer.

17. The polymer composition of claim 5, wherein the polymer composition has a heat deformation at 121° C. of less than 30%.

18. A flexible and high temperature rated cable jacket material comprising the composition of claim 1.

19. A cable, comprising a flexible outer sheath comprising the composition of claim 1, the sheath having a flexural modulus below 30,000 psi (206.9 MPa) as measured by ASTM D-790, and a heat deformation of less than 30% (at 121° C.) as measured by ASTM D-4565.
